(19) United States
(12) Patent Application Publication
(10) Pub. No.: US 2006/0112203 A1
(43) Pub. Date: May 25, 2006

(54) Portable all-in-one digital data storage converter

(76) Inventor: Kuang-Han Lee, Chung-Ho City (TW)

Correspondence Address: Power 7 Technology Corp., P.O. Box No. 6-57, Junghe, Taipei, 235, TW

(21) Appl. No.: 10/991,410

(22) Filed: Nov. 19, 2004

(51) Int. Cl. G06F 13/12

(52) U.S. Cl. 710/74

(57) ABSTRACT

A portable all-in-one digital data converter includes a power circuit, a micro processing unit (MCU), a card reading chip, a USB connector and a memory card slot. Without requiring a computer as a media, the portable all-in-one digital data converter allows digital data exchange and storage between various storage media as desired.

### BACKGROUND OF THE INVENTION

(a) Field of the Invention

The invention relates to a portable all-in-one digital data storage converter, and more particularly, to a converter that, without requiring computers as media, allows digital data exchange and storage as desired between various data storage media.

(b) Description of the Prior Art

Accompanied with rapid advancement of information technology, transmission rate and storage capacity of digital data are being significantly increased as well. Huge amounts of digital data are stored and accessed by computers from storage media such as memory cards, portable disks, pen recorders, personal digital assistants (PDA), personal video recorders (PVR), digital static cameras (DSC), universal serial bus (USB) compact disk read-only-memories (CD-ROM), audio/video (A/V) decoders, motion picture expert group 2layer3 (MP3) players, and card readers. In order to transmit data between these information devices, a commonly used method is to connect cables of these information devices to a computer, and then to transmit and store, or access one another's digital data using a computer host as a medium. However, this method is only completed in the presence of media namely computer hosts, meaning that a computer host is necessarily available at the time of transmission. It is recognized that computers are not always obtainable in actual situations, or one may not definitely find idle computers that can be applied. Thus, perplexities are often caused.

### SUMMARY OF THE INVENTION

In the view of the aforesaid shortcomings of prior methods for transmitting and storing digital data, the invention provides a novel portable all-in-one digital data storage converter.

The primary object of the invention is to provide a digital data storage converter which, without requiring a computer as a medium, enables digital data to exchange and be stored between various storage media as desired.

To accomplish the aforesaid object, a portable all-in-one data storage converter according to the invention comprise a power circuit, a card reading chip, a micro processing unit (MCU), a USB connector and a memory card slot. To transmit digital data from a memory card to a portable disk, the memory card and the portable disk are respectively inserted into the USB connector and the memory card slot, and data transmission and storage are then completed via the card reading chip and the MCU.

According to the aforesaid structure, without requiring a computer as a medium, digital data can be exchanged and stored between various storage media as desired.

### BRIEF DESCRIPTION OF THE DRAWINGS

FIG. 1 shows a circuit block diagram according to the invention.

### DETAILED DESCRIPTION OF THE PREFERRED EMBODIMENTS

To better understand structures, devices and characteristics of the invention, detailed descriptions shall be given with the accompanying drawings below.

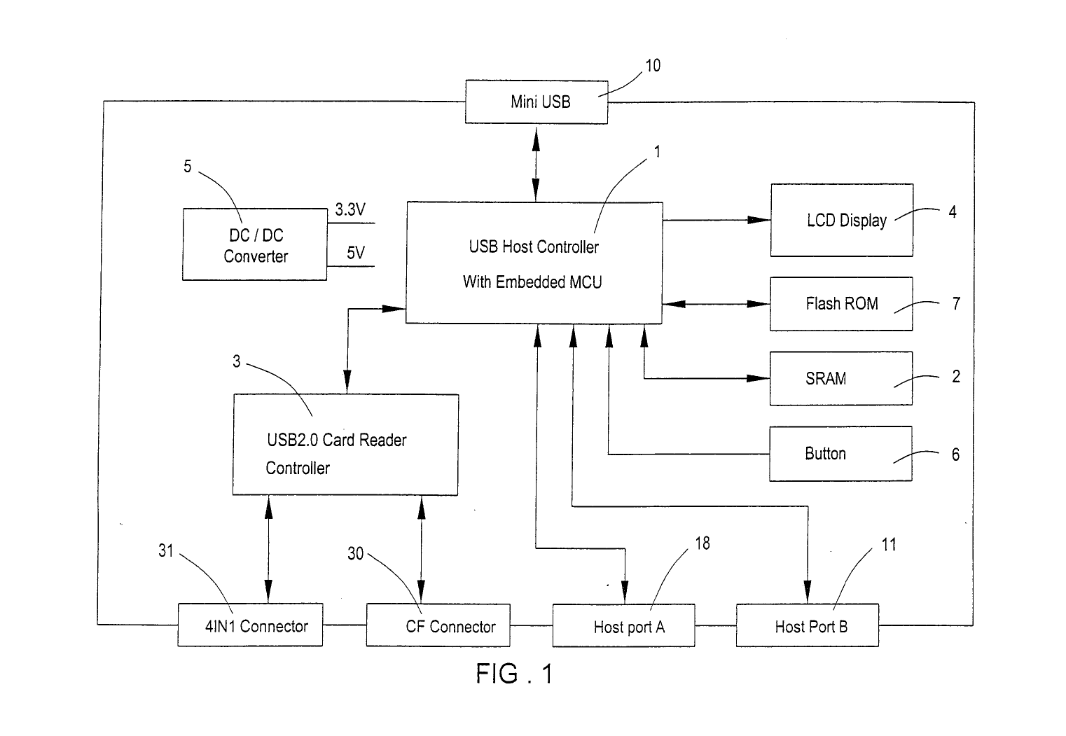

Referring to FIG. 1, a portable all-in-one digital data storage converter according to the invention comprises a micro processing unit (MCU) 1, a memory 2, an all-in-one card reading chip 3, a liquid crystal display (LCD) 4, a power circuit 5, a keyboard 6 and a flash memory 7. The invention is characterized that:

the MCU 1 is for controlling internal circuits; and is connected with a mini USB connector 10, and two USB connector 11 and 18, as well as being connected to the memory 2, the all-in-one card reading chip 3, the LCD 4, the power circuit 5, and keyboard 6 and the flash memory 7;

the all-in-one card reading chip 3 is connected with a compact flash slot 30, a four-in-one memory card slot 31 and the MCU 1; and is for converting data stored in a memory card into USB-formatted data, and then outputting the data to an external device via the USB connector 11;

the LCD 4 is connected with the MCU, and is for displaying operation commands and power supply status;

the power circuit 5 is connected with the MCU 1, and is for supplying the MCU 1 with operational electrical power;

the keyboard 6 is connected with the MCU 1, and is for inputting control signals to further control operations of the MCU 1;

the flash memory 7 is connected with the MCU 1, and is for storing USB-formatted data; and

the four-in-one memory card slot 31 is connected with the all-in-one card reading chip 3, and has an internally disposed memory stick/memory stick PRO connector, MMC/SD connector or smart media connector.

In addition, an external device such as a portable disk, a pen recorder, a PDA, a PVR, a DSC, a USB CD-ROM, an A/V decoder, a USB MP3 player or a card reader is connected using a mini USB or USB connector. Also, the compact flash slot 30 is inserted with a compact flash memory card; and the four-in-one memory card slot 31 is inserted with a memory card in form of memory stick, memory stick PRO, MMC, SD or smart media.

According to the aforesaid structure, supposed digital data stored in a storage medium like a compact flash card are to be transmitted to another storage medium like a portable disk, the compact flash card is inserted into the compact flash slot 30 of the portable all-in-on digital data converter according to the invention, while a USB plug of the portable disk is inserted into the USB connector 11. When the MCU 1 and the all-in-one card reading chip 3 detect orientation of the portable disk and the compact flash card, a signal is outputted to the LCD 4. The LCD 4 displays a text signal commanding a user to select operations using the keyboard 6. The user is allowed to select transmitting data either from the compact flash card to the portable disk, or from the portable disk to the compact flash card. Data transmission is confirmed and processed by pressing an enter key on the keyboard 6.

According to the aforesaid descriptions, supposed the user chooses to transmit data from the compact flash card to the portable disk, the MCU outputs a control signal to enable the all-in-one card reading chip 3 to read data in the compact flash card, with the data temporarily stored in the memory 2. When a certain quantity of data is stored in the memory 2, the data are converted into USB-formatted data by the all-in-one card reading chip 3. The USB-formatted data are transmitted to the portable disk via the MCU 1 and the USB connector 11, and stored therein, thereby completing data exchange between two different data storage media.

In addition, according to the portable all-in-one digital data converter, common electric cells are used to supply electric power instead of externally connected power supplies. Therefore, the invention is provided with enhanced portability, so that a user is allowed to exchange data stored in two storage media as desired at all times without having to connect the storage media to a computer.

Conclusive from the aforesaid descriptions, the portable all-in-one digital data converter according to the invention indeed performs data exchange between various storage media for enhancing convenience of data storage. It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A portable all-in-one digital data converter comprises a micro processing unit (MCU), a memory, an all-in-one card reading chip, a liquid crystal display (LCD), a power circuit and a keyboard; and being characterized that:
the MCU is for controlling internal circuits; and is connected with a mini USB connector, and two USB connector, as well as being connected to the memory, the all-in-one card reading chip, the LCD, the power circuit, and keyboard and the flash memory;
the memory is for temporarily storing data in exchange, and is connected with the MCU;
the all-in-one card reading chip is connected with a compact flash slot, a four-in-one memory card slot and the MCU; and is for converting data stored in a memory card into USB-formatted data, and then outputting the data to an external device via the USB connector;
the LCD is connected with the MCU, and is for displaying operation commands and power supply status;
the power circuit is connected with the MCU, and is for supplying the MCU with operational electrical power;
the keyboard is connected with the MCU, and is for inputting control signals to further control operations of the MCU;
the flash memory is connected with the MCU, and is for storing USB-formatted data; and
the four-in-one memory card slot is connected with the all-in-one card reading chip, and has an internally disposed memory stick/memory stick PRO connector, MMC/SD connector and smart media connector.

2. The portable all-in-one digital data converter in accordance with claim 1, wherein the MCU is connected with a flash memory card.

3. The portable all-in-one digital data converter in accordance with claim 1, wherein the four-in-one memory card slot is connected with the all-in-one card reading chip; and has a memory stick connector, a memory stick PRO connector, an MMC connector, a SD or smart media connector.
